(19) United States
(12) Patent Application Publication
(10) Pub. No.: US 2010/0017214 A1
(43) Pub. Date: Jan. 21, 2010

(54) EXTENDED SERVICES ORIENTED ARCHITECTURE FOR DISTRIBUTED ANALYTICS

(76) Inventors: Ronald Ambrosio, Poughquag, NY (US); Robert V. Arthur, South Jordan, UT (US); John Z. Dorn, Erwinna, PA (US); Anthony F. Hays, Aurora, IL (US); Jeffery D. Taft, Canonsburg, PA (US); Mark G. Yao, New York, NY (US)

Correspondence Address: DILLON & YUDELL LLP, 8911 N. CAPITAL OF TEXAS HWY.,, SUITE 2110, AUSTIN, TX, 78759, US

(21) Appl. No.: 12/173,202

(22) Filed: Jul. 15, 2008

(51) Int. Cl. G06Q 10/00

(52) U.S. Cl. 705/1; 705/412

(57) ABSTRACT

A distributed processing service is configured between an Enterprise Service Bus (ESB), which supports a Service Oriented Architecture (SOA) for delivering utility services, and a Sensor Data/Event Processing Bus, which receives data communication from sensors on a utility grid. The distributed processing service provides middleware that allows the event-driven Sensor Data/Event Processing Bus to communicate with the transaction-drive ESB, thus permitting the delivery of services from the SOA to the utility grid.

### BACKGROUND OF THE INVENTION

1. Technical Field

The present disclosure relates in general to the field of utility distribution grids, and particularly to managing utility distribution grids. Still more particularly, the present disclosure relates to interfacing utility distribution grids with services provided in a Services Oriented Architecture (SOA).

2. Description of the Related Art

Utility systems, including electric utilities, increasingly utilize intelligent grids, such as power grids that are augmented with sensors, communications networks, substation automation, distribution automation, sensor data storage, and sensor analytics that increase grid observability and controllability. A major problem that electric utilities face is how to manage the flood of data that an intelligent grid can produce. Further, because of the real time and distributed nature of electric grid assets, the problem of integrating embedded real time intelligence with utility operations systems and back office systems and processes is difficult. Conventional architectures, in particular a standard Services Oriented Architecture (SOA), do not provide useful means to solve these data management and integration problems because they do not address three major characteristics of intelligent grids: distributed embedded intelligence, geospatial distribution of the utility assets and therefore the data management functions, and wide time scale distribution (some functions must act in milliseconds, others act over months).

Furthermore, the distributed assets of a utility can and do generate vast amounts of data continuously, which is too much data to store in conventional relational databases, and is far too much data to be handled by standard SOA services (since a primary premise of SOA is that services communicate via sockets and/or Web services interfaces that are not conducive to large data flows). Furthermore, the data generated by intelligent systems is far too much data for humans to monitor and comprehend.

In addition, a traditional SOA is inadequate to address the joint requirements of end-to-end data management and analytics integration for the intelligent electric distribution grid and the electric utility enterprise.

### SUMMARY OF THE INVENTION

A distributed processing service is configured between an Enterprise Service Bus (ESB), which supports a Service Oriented Architecture (SOA) for delivering utility services, and a Sensor Data/Event Processing Bus, which receives data communication from sensors on a utility grid. The distributed processing service provides middleware that allows the event-driven Sensor Data/Event Processing Bus to communicate with the transaction-drive ESB, thus permitting the delivery of services from the SOA to the utility grid.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 illustrates an exemplary computer in which the present invention may be utilized;

FIG. 2 depicts a high-level overview of a novel set of distributed processing services that provide an interface between a transaction-based Enterprise Service Bus (ESB) and an event-based Sensor Data/Event Processing Bus;

FIG. 3 illustrates an intelligent RTU coupled to a utilities distribution line;

FIG. 4 depicts additional detail of the distributed processing services illustrated in FIG. 2;

FIG. 5 is a high-level flow-chart describing steps for configuring and utilizing distributed processing services to manage a utility grid;

FIGS. 6A-B are flow-charts showing steps taken to deploy software capable of executing the steps and processes described in FIGS. 2-5; and

FIGS. 7A-B are flow-charts showing steps taken to execute the steps and processes shown in FIGS. 2-5 using an on-demand service provider;

### DETAILED DESCRIPTION OF THE PREFERRED EMBODIMENT

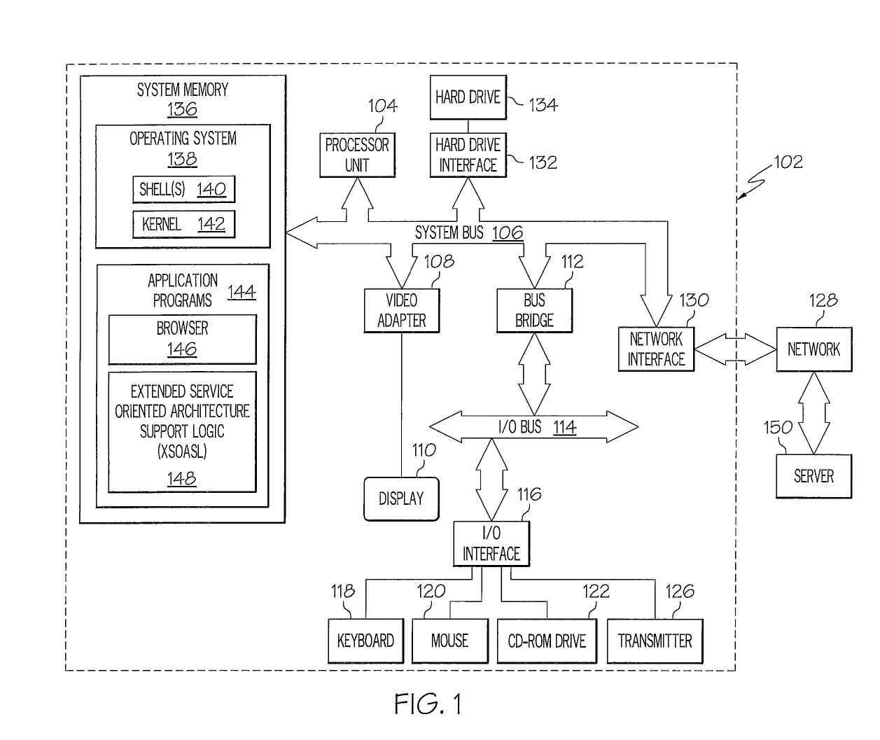

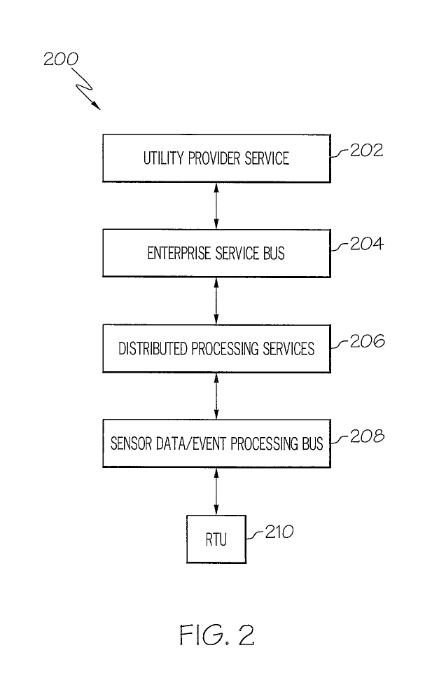

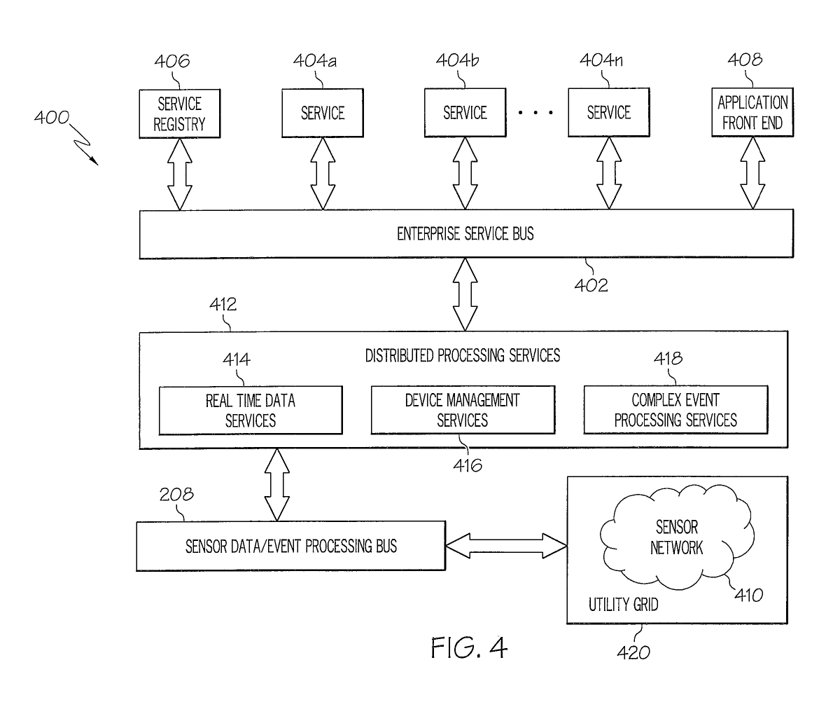

With reference now to FIG. 1, there is depicted a block diagram of an exemplary computer 102, in which the present invention may be utilized. Note that some or all of the exemplary architecture shown for computer 102 may be utilized by software deploying server 150, as well as computers (not shown) that may be utilized to implement the services and support the busses illustrated in FIGS. 2 and 4.

Computer 102 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, a floppy disk drive 124, and a transmitter 126. Transmitter 126 may be a wire-based or wireless-based transmitter, capable of transmitting a signal over a wire or a wireless signal (e.g., a radio wave). The format of the ports connected to I/O interface 116 may be any known to those skilled in the art of computer architecture, including but not limited to Universal Serial Bus (USB) ports.

Computer 102 is able to communicate with a software deploying server 150 via a network 128 using a network interface 130, which is coupled to system bus 106. Network 128 may be an external network such as the Internet, or an internal network such as an Ethernet or a Virtual Private Network (VPN). Note the software deploying server 150 may utilize a same or substantially similar architecture as computer 102.

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (also called a command processor) is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a browser 146. Browser 146 includes program modules and instructions enabling a World Wide Web (WWW) client (i.e., computer 102) to send and receive network messages to the Internet using HyperText Transfer Protocol (HTTP) messaging, thus enabling communication with software deploying server 150.

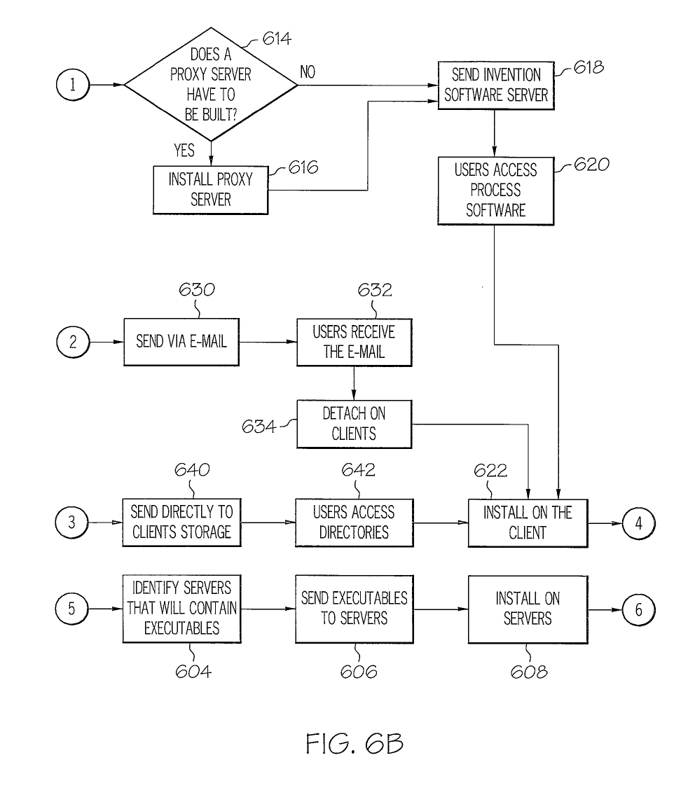

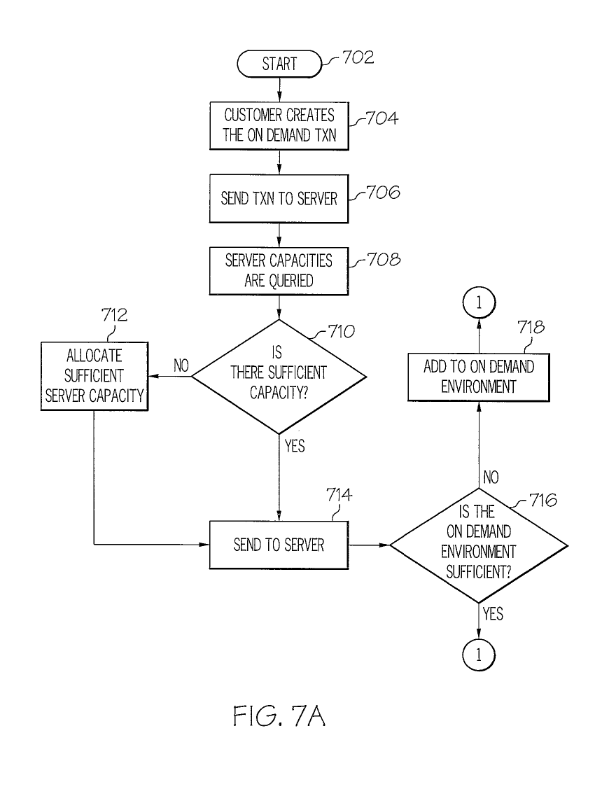

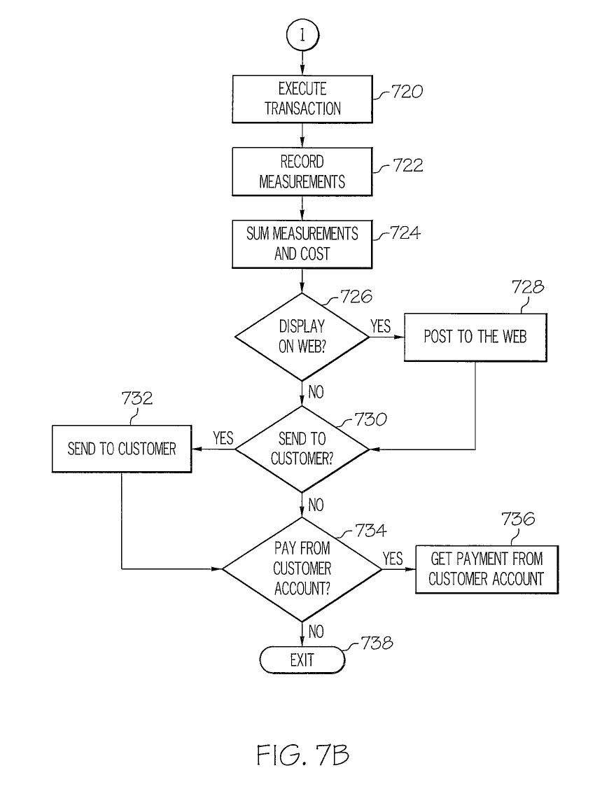

Application programs 144 in computer 102's system memory (as well as software deploying server 150's system memory) also include an Extended Service Oriented Architecture Support Logic (XSOASL) 148. XSOASL 148 includes code for implementing the processes described in FIGS. 2-7B. In one embodiment, computer 102 is able to download XSOASL 148 from software deploying server 150, including in an “on demand” basis, as described in greater detail below in FIGS. 6A-7B. Note further that, in a preferred embodiment of the present invention, software deploying server 150 performs all of the functions associated with the present invention (including execution of XSOASL 148), thus freeing computer 102 from having to use its own internal computing resources to execute XSOASL 148.

The hardware elements depicted in computer 102 are not intended to be exhaustive, but rather are representative to highlight essential components required by the present invention. For instance, computer 100 may include alternate memory storage devices such as magnetic cassettes, Digital Versatile Disks (DVDs), Bernoulli cartridges, and the like. These and other variations are intended to be within the spirit and scope of the present invention.

With reference now to FIG. 2, a high-level overview of how a novel set of distributed processing services 206 interfaces between an Enterprise Service Bus (ESB) 204 and a Sensor Data/Event Processing Bus (SDEPB) 208. The ESB 204 is a transaction-based bus that supports a Service Oriented Architecture (SOA). An SOA is a computer architecture that defines software services (e.g., a utility provider service 202), which are able to interact with a customer via the ESB, thus creating a complete software solution for a customer. That is, multiple software services (of which utility provider service 202 is one) are able to communicate with one another and the customer via transactions (sessions in which data and requests are exchanged between services) using the ESB 204. Because of its transaction-based orientation, ESB 204 is a relatively slow bus, since “handshakes” and other quality and security assurance protocols have to be maintained. The SDEPB 208, however, is a much faster bus. Since SDEPB 208 is event-based, most of the data being sent from a Remote Terminal Unit (RTU) 210, which is a sensor described in further detail below, is asynchronous (“one-way”). Because of their different protocols, timing structures, and architectures, ESB 204 and SDEPB 208 are unable to directly communicate with one another. However, the novel distributed processing services 206 provide the requisite interface needed for such communication.

Consider now an exemplary use of the architecture 200 shown in FIG. 2. Assume that RTU 210 is a sensor that is coupled to an electrical power meter at a customer's location. Assume also that utility provider service 202 is a complex service that sells electricity at fluctuating costs. Thus, the cost of a kilowatt-hour of electricity may vary by several percentage points over the course of a day. At some point in the day, the RTU 210 may indicate that additional electric power is needed to run an auxiliary air conditioner that belongs to the customer. Logic within the SDEPB 208 may be able to calculate how much power is needed, due to the event-driven nature of the SDEPB 208. Similarly, the ESB 204 may be able to determine how much power is available from the utility provider service 202 and at what cost (in real-time), due to the transaction-driven nature of the ESB 204. However, it is only with the introduction of the novel distributed processing services 206 that an interface can correlate the needs of the customer (based on reading from the RTU 210 and a pre-established customer budget stored in the distributed processing services 206) with the supply and pricing of the service from the utility provider service 202 (found on the ESB 204).

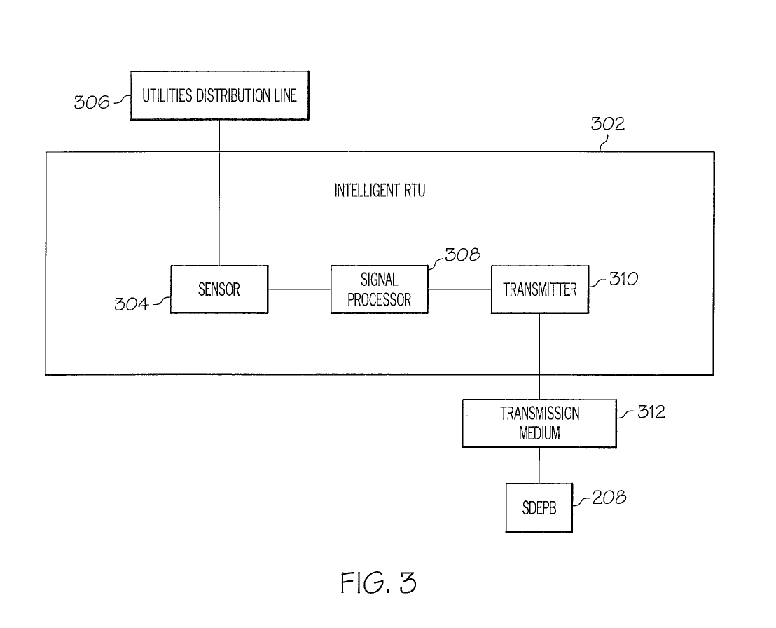

Referring now to FIG. 3, an exemplary intelligent RTU 302, which may function as the RTU 210 shown in FIG. 2, is depicted. Intelligent RTU 302 includes a sensor 304, which is coupled to a utilities distribution line 306. The utilities distribution line 306 may be an electric power line (e.g., a service drop line coming directly into a customer's location), a natural gas (or other hydrocarbon gas) line, a water line, or any other utility. A signal processor 308 is able to process readings from sensor 304, in order to calculate elements such as power load factors, wasted power (volt-amperes reactive), etc. This processed data can then be transmitted via a transmitter 310, which may be wired (e.g., sends signals along a dedicated low-voltage data line and/or along a power line itself) or wireless (e.g., sends radio frequency signals to a local or cellular receiver using a transmitter such as transmitter 126 shown in FIG. 1). The processed sensor data is then transmitted along the transmission medium 312 (either wired or wirelessly) to the SDEPB 208 for further processing.

Note that in one embodiment, the RTU 210 shown in FIG. 2 is made up of only the sensor 304 shown in FIG. 3, and thus RTU 210 is a “dumb” sensor. In this scenario, the signal processing and other capabilities described for the intelligent RTU 302 must be performed by other logic (e.g., logic within the SDEPB 208).

Consider now that architecture 400 shown in FIG. 4. An Enterprise Service Bus 402 (similar to that described in FIG. 2 for ESB 204) supports a Service Oriented Architecture (SOA), which includes the services 404a-n (where “n” is an integer). Coordination between the services 404a-n is afforded by a service registry 406, which keeps track of which services are available in the SOA supported by ESB 402. An application front end 408 allows an SOA supervisor to monitor activities in the SOA.

At the customer-end of the architecture 400 is a sensor network 410, which measures/monitors activity on a utility grid 420. This sensor network 410 is made up of RTUs, which are “dumb” (sensors only) and/or “intelligent” (i.e., intelligent RTU 302 described in FIG. 3.) Sensor data, either raw (from a dumb sensor) or semi-processed (from an intelligent RTU) is sent to SDEPB 208. Again, note that SDEPB 208, while very fast, does not support transactions, since it is an asynchronous (“one-way”) bus.

The SDEPB 208, having sensed and received the sensor data from the sensor network 410, transmits this sensor data to the distributed processing services 412 (which is similar to the distributed processing services 206 shown in FIG. 2). Within distributed processing services 412 is a set of real time data services 414 that monitor the SDEPB 208 for new sensor data, and passes this data (in some embodiments, after further processing) to the ESB 402. A set of device management services 416 provides that ability to the application front end 408 to remotely update software associated with the SDEPB 208 and/or intelligent sensors in the sensor network 410. A set complex event processing services 418 provides the complex logic needed to correlate events, which are detected by sensors in the sensor network 410, with services offered in the SOA supported by the ESB 402. Exemplary services provided by the complex event processing services 418 include, but are not limited to, the following.

Remote Terminal Sensor Data Services These services manage, measure and publish a grid state of the utility grid 420. For example, on an electric grid, these services may monitor power shortfalls, intermittently open/closed switches, etc. Furthermore, these services provide drill-down data analysis of sensor data. For example, if a sensor detects a high level of electrical “noise” on a power line, these services have the intelligence logic to evaluate likely sources of such noise (e.g., faulty transformers, capacitance-inducing proximate lines, etc.). These services can also digitize sensor data into a digital waveform, which can be transmitted to the application front end 408 for display and evaluation.

Outage Intelligence Services These services detect outages based on a lack of sensor data being produced by select sensors on the sensor network 410. These services can determine a root cause analysis by evaluating and correlating other sensor events. For example, assume that the sensor network 410 provides meter data from houses on a particular street. Also assume that the last three houses on the street all show no power coming through their meters. The outage intelligent services can then determine, based on readings from all sensors on the street, that the problem originated somewhere downstream of the fourth house from the end of the street.

Asset Analytics Services These services perform trending on equipment stress data from a historian, in order to perform a running calculation of Loss of Life (LoL), Estimated Time to Failure (ETTF), Asset Failure System Risk (AFSR), and Asset Profitability. That is, based on the type and frequency of sensor data anomalies produced by the sensor network 410, these services can predict which hardware (e.g., meters, transformers, lines, etc.) are likely to fail, and what the results of such failure (e.g., fire, loss of power to mission-critical or life-supporting systems, etc.) would be.

While the services described above are exemplary and non-limiting, it is understood that additional services may be needed to support the described services. Such additional services include, but are not limited to, portal and web services (for providing output interfaces to users), Message Broker Services to support the ESB, applications management services, network monitoring services (to monitor network devices), etc.

Furthermore, once the distributed processing services 412 processes the sensor data, this processed data can be used to initiate work orders (e.g., to repair a transformer), create a real-time visualization of the health of the utility grid, establish control procedures to prevent and/or control faults in the utility grid, delay reclosing of relays and/or switches until primary and/or secondary line arcs are extinguished (which can be determined from real time waveform analysis of the sensor data), etc.

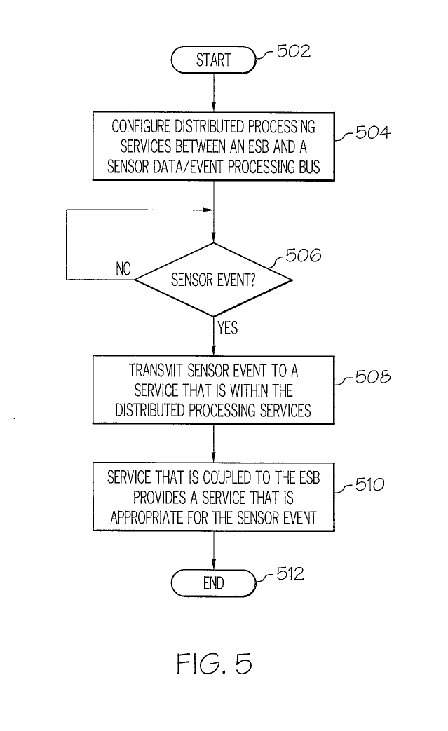

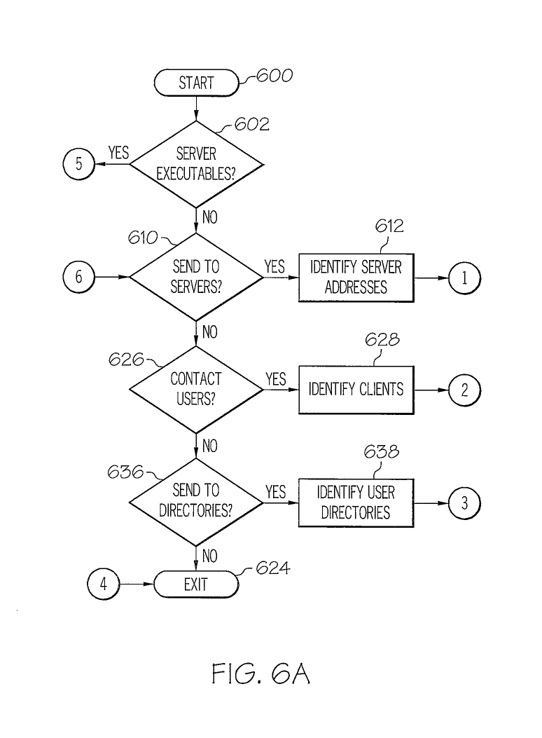

Referring now to FIG. 5, a high-level flow-chart of exemplary steps taken to manage a utility grid using distributed processing services is presented. After initiator block 502, distributed processing services (as described above in exemplary manner in FIGS. 2 and 4) are configured (block 504). When a sensor event is detected (query block 506), sensor data is sent from the sensor (e.g., via SDEPB 208 described above) to one or more of the intermediate services provided by the distributed processing services (block 508). The distributed processing services process the sensor data, to achieve a request for service from the SOA that is supported by the ESB, which then returns the requested service (e.g., additional electric power) to the customer (block 510). The process ends at terminator block 512.

It should be understood that at least some aspects of the present invention may alternatively be implemented in a computer-readable medium that contains a program product. Programs defining functions of the present invention can be delivered to a data storage system or a computer system via a variety of tangible signal-bearing media, which include, without limitation, non-writable storage media (e.g., CD-ROM), writable storage media (e.g., hard disk drive, read/write CD ROM, optical media), as well as non-tangible communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

### Software Deployment

As described above, in one embodiment, the processes described by the present invention, including the functions of XSOASL 148, are performed by service provider server 150. Alternatively, XSOASL 148 and the method described herein, and in particular as shown and described in FIGS. 2-5, can be deployed as a process software from service provider server 150 to computer 102. Still more particularly, process software for the method so described may be deployed to service provider server 150 by another service provider server (not shown).

Referring then to FIGS. 6A-B, step 600 begins the deployment of the process software. The first thing is to determine if there are any programs that will reside on a server or servers when the process software is executed (query block 602). If this is the case, then the servers that will contain the executables are identified (block 604). The process software for the server or servers is transferred directly to the servers' storage via File Transfer Protocol (FTP) or some other protocol or by copying though the use of a shared file system (block 606). The process software is then installed on the servers (block 608).

Next, a determination is made on whether the process software is to be deployed by having users access the process software on a server or servers (query block 610). If the users are to access the process software on servers, then the server addresses that will store the process software are identified (block 612).

A determination is made if a proxy server is to be built (query block 614) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 616). The process software is sent to the servers either via a protocol such as FTP or it is copied directly from the source files to the server files via file sharing (block 618). Another embodiment would be to send a transaction to the servers that contained the process software and have the server process the transaction, then receive and copy the process software to the server's file system. Once the process software is stored at the servers, the users, via their client computers, then access the process software on the servers and copy to their client computers file systems (block 620). Another embodiment is to have the servers automatically copy the process software to each client and then run the installation program for the process software at each client computer. The user executes the program that installs the process software on his client computer (block 622) then exits the process (terminator block 624).

In query step 626, a determination is made whether the process software is to be deployed by sending the process software to users via e-mail. The set of users where the process software will be deployed are identified together with the addresses of the user client computers (block 628). The process software is sent via e-mail to each of the users' client computers (block 630). The users then receive the e-mail (block 632) and then detach the process software from the e-mail to a directory on their client computers (block 634). The user executes the program that installs the process software on his client computer (block 622) then exits the process (terminator block 624).

Lastly a determination is made as to whether the process software will be sent directly to user directories on their client computers (query block 636). If so, the user directories are identified (block 638). The process software is transferred directly to the user's client computer directory (block 640). This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software (block 642). The user executes the program that installs the process software on his client computer (block 622) and then exits the process (terminator block 624).

### VPN Deployment

The present software can be deployed to third parties as part of a service wherein a third party VPN service is offered as a secure deployment vehicle or wherein a VPN is build on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling which is the process of placing an entire packet within another packet and sending it over a network. The protocol of the outer packet is understood by the network and both points, called tunnel interfaces, where the packet enters and exits the network.

### Software Integration

The process software which consists of code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers, including the network operating system where the process software will be deployed, that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists match the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

### On Demand

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the accessed server may make requests of other servers that require CPU units. CPU units describe an example that represents but one measurement of use. Other measurements of use include but are not limited to network bandwidth, memory utilization, storage utilization, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory utilization, storage utilization, etc. approach a capacity so as to affect performance, additional network bandwidth, memory utilization, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and/or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

With reference now to FIGS. 7A-B, initiator block 702 begins the On Demand process. A transaction is created than contains the unique customer identification, the requested service type and any service parameters that further, specify the type of service (block 704). The transaction is then sent to the main server (block 706). In an On Demand environment the main server can initially be the only server, then as capacity is consumed other servers are added to the On Demand environment.

The server central processing unit (CPU) capacities in the On Demand environment are queried (block 708). The CPU requirement of the transaction is estimated, then the server's available CPU capacity in the On Demand environment are compared to the transaction CPU requirement to see if there is sufficient CPU available capacity in any server to process the transaction (query block 710). If there is not sufficient server CPU available capacity, then additional server CPU capacity is allocated to process the transaction (block 712). If there was already sufficient available CPU capacity then the transaction is sent to a selected server (block 714).

Before executing the transaction, a check is made of the remaining On Demand environment to determine if the environment has sufficient available capacity for processing the transaction. This environment capacity consists of such things as but not limited to network bandwidth, processor memory, storage etc. (block 716). If there is not sufficient available capacity, then capacity will be added to the On Demand environment (block 718). Next the required software to process the transaction is accessed, loaded into memory, then the transaction is executed (block 720).

The usage measurements are recorded (block 722). The utilization measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 724).

If the customer has requested that the On Demand costs be posted to a web site (query block 726), then they are posted (block 728). If the customer has requested that the On Demand costs be sent via e-mail to a customer address (query block 730), then these costs are sent to the customer (block 732). If the customer has requested that the On Demand costs be paid directly from a customer account (query block 734), then payment is received directly from the customer account (block 736). The On Demand process is then exited at terminator block 738.

As described herein, the present invention provides distributed autonomous agents that can operate on distributed databases to continuously execute distributed analytics that transform the grid data and event messages into information that can be acted on automatically (device control, crew dispatch, switching for fault isolation and outage management, etc.) or that can support informed human decision making. Traditional SOA would at best push all this into an application front end; thereby essentially ignoring the problem and providing no help or even guidance on a solution. The present invention, however, provides an architecture and a standardized set of services under that architecture that are implemented over two integration buses rather than the conventional single integration bus of standard SOA. The second bus is a sensor data and event correlation bus which provides the means to integrate the sensor data and event message streams and associated analytics with both utility operations systems and utility back office systems.

The present invention further provides for both distributed intelligence (with centrally managed applications and applications distribution support) and for distributed data storage that is compatible with the Common Information Model approach to utility data schema now being adopted by the electric power industry. The present invention further provides for a number of specific standardized services that support intelligent distribution grid functionality. The present invention therefore provides both a framework and specific components crucial to implementation of intelligent power distribution grids. The architecture described herein also provides a structure for the integration of so-called Advanced Meter Infrastructure (AMI) so that remotely-read meter systems may be used as fine-grained sensor networks in support of various grid analytics functions, including outage intelligence and grid device control.

While the present invention has been particularly shown and described with reference to a preferred embodiment, it will be understood by those skilled in the art that various changes in form and detail may be made therein without departing from the spirit and scope of the invention. For example, while the present description has been directed to a preferred embodiment in which custom software applications are developed, the invention disclosed herein is equally applicable to the development and modification of application software. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A method of managing a utility grid, the method comprising:
configuring a distributed processing service between an Enterprise Service Bus (ESB) and a Sensor Data/Event Processing Bus, wherein the ESB provides data communication to at least one utility service offered in a Service Oriented Architecture (SOA), wherein the at least one utility service is capable of delivering a utility to one or more customers on a utility grid, and wherein the Sensor Data/Event Processing Bus receives data communication from at least one sensor on the utility grid;
in response to the distributed processing service receiving a sensor event from said at least one sensor on the utility grid, preparing a request for delivery of the utility from said at least one utility services offered in the SOA;
transmitting the request for delivery of the utility from the distributed processing service to the ESB; and
in response to the ESB receiving the request for delivery of the utility, delivering the utility to the utility grid.

2. The method of claim 1, wherein the sensor is an intelligent Remote Terminal Unit (RTU).

3. The method of claim 2, wherein the intelligent RTU is coupled to a customer's facility that is on the utility grid.

4. The method of claim 3, wherein the sensor event is a request to provide the utility to the customer's facility.

5. The method of claim 4, further comprising:
using a complex event processing service, in the distributed processing service, to determine a real-time acceptable price for the utility.

6. The method of claim 5, further comprising:
in response to said one of the services offered in the SOA meeting the real-time acceptable price for the utility, providing the utility to the customer's facility.

7. The method of claim 6, wherein the utility is electricity.

8. The method of claim 6, wherein the utility is a hydrocarbon gas.

9. The method of claim 2, wherein the sensor event results in an advanced analytical analysis performed by the intelligent RTU, wherein the advanced analytical analysis includes digitizing an electric power waveform measured by the intelligent RTU, and wherein the method further comprises:
streaming digitized electric power waveforms to a control center server for real-time display of the electric power waveform measured by the intelligent RTU.

10. A distributed processing service comprising:
middleware configured to correlate sensor events with services offered in a Service Oriented Architecture (SOA), wherein the distributed processing service is logically oriented between an Enterprise Service Bus (ESB) and a Sensor Data/Event Processing Bus, wherein the ESB provides data communication to at least one utility service offered in the SOA, wherein the at least one utility service is capable of delivering a utility to one or more customers on a utility grid, and wherein the Sensor Data/Event Processing Bus receives data communication from at least one sensor on the utility grid; and
complex event processing services logic for:
in response to the distributed processing service receiving a sensor event from said at least one sensor on the utility grid, preparing a request for delivery of the utility from said at least one utility services offered in the SOA;
transmitting the request for delivery of the utility to the ESB;
receiving a requested utility from the ESB; and
delivering the requested utility to the utility grid.

11. A computer-readable medium on which is stored a computer program, the computer program comprising computer executable instructions configured for:
configuring a distributed processing service between an Enterprise Service Bus (ESB) and a Sensor Data/Event Processing Bus, wherein the ESB provides data communication to at least one utility service offered in a Service Oriented Architecture (SOA), wherein the at least one utility service is capable of delivering a utility to one or more customers on a utility grid, and wherein the Sensor Data/Event Processing Bus receives data communication from at least one sensor on the utility grid;
in response to the distributed processing service receiving a sensor event from said at least one sensor on the utility grid, preparing a request for delivery of the utility from said at least one utility service offered in the SOA;
transmitting the request for delivery of the utility from the distributed processing service to the ESB; and
in response to the ESB receiving the request for delivery of the utility, delivering the utility to the utility grid.

12. The computer-readable medium of claim 11, wherein the sensor is an intelligent Remote Terminal Unit (RTU).

13. The computer-readable medium of claim 12, wherein the intelligent RTU is coupled to a customer's facility that is on the utility grid.

14. The computer-readable medium of claim 13, wherein the sensor event is a request to provide the utility to the customer's facility.

15. The computer-readable medium of claim 14, wherein the computer executable instructions are further configured for:
using a complex event processing service, in the distributed processing service, to determine a real-time acceptable price for the utility.

16. The computer-readable medium of claim 15, wherein the computer executable instructions are further configured for:
in response to said one of the services offered in the SOA meeting the real-time acceptable price for the utility, providing the utility to the customer's facility.

17. The computer-readable medium of claim 16, wherein the utility is electricity.

18. The computer-readable medium of claim 12, wherein the sensor event results in an advanced analytical analysis performed by the intelligent RTU, wherein the advanced analytical analysis includes digitizing an electric power waveform measured by the intelligent RTU, and wherein the computer executable instructions are further configured for:
streaming digitized electric power waveforms to a control center server for real-time display of the electric power waveform measured by the intelligent RTU.

19. The computer-readable medium of claim 11, wherein the computer-readable medium is a component of a remote server, and wherein the computer executable instructions are deployable to a supervisory computer from the remote server.

20. The computer-readable medium of claim 11, wherein the computer executable instructions are capable of being provided by a service provider to a customer on an on-demand basis.
